(19) United States
(12) Patent Application Publication
(10) Pub. No.: US 2026/0003509 A1
(43) Pub. Date: Jan. 1, 2026

(54) CONFIGURABLE WRITE PROCESSING SPEEDS AT A MEMORY SYSTEM

(71) Applicant: Micron Technology, Inc., Boise, ID (US)

(72) Inventor: Wenjun Wu, Shanghai (CN)

(21) Appl. No.: 19/235,359

(22) Filed: Jun. 11, 2025

Related U.S. Application Data
(60) Provisional application No. 63/666,072, filed on Jun. 28, 2024.

(51) Int. Cl. G06F 3/06; G06F 12/1009

(52) U.S. Cl. CPC G06F 3/0617; G06F 3/0659; G06F 3/0673; G06F 12/1009

(57) ABSTRACT

Methods, systems, and devices for configurable write processing speeds at a memory system are described. The described techniques provide for a memory system to slow a write processing speed when the memory system identifies that entries within an active foreground changelog (AL) correspond to a threshold quantity of memory regions. Slowing the write processing speed may allow for additional time for the memory system flush logical-to-physical (L2P) mappings from a background changelog (BL) while still receiving write commands and populating the AL with new L2P mappings. For example, slowing the write processing speed may increase a duration associated with new L2P mappings within the AL satisfying the threshold quantity of memory regions and may enable the memory system to increase the threshold quantity of memory regions without incurring additional latency when flushing L2P mappings to the memory arrays.

### CROSS REFERENCE

The present Application for Patent claims priority to U.S. Patent Application No. 63/666,072 by Wu, entitled “CONFIGURABLE WRITE PROCESSING SPEEDS AT A MEMORY SYSTEM,” filed Jun. 28, 2024, which is assigned to the assignee hereof, and which is expressly incorporated by reference in its entirety herein.

### TECHNICAL FIELD

The following relates to one or more systems for memory, including configurable write processing speeds at a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports configurable write processing speeds at a memory system in accordance with examples as disclosed herein.

FIG. 2 shows an example of a changelog management scheme that supports configurable write processing speeds at a memory system in accordance with examples as disclosed herein.

FIG. 3 shows an example of a process that supports configurable write processing speeds at a memory system in accordance with examples as disclosed herein.

FIG. 4 shows a block diagram of a memory system that supports configurable write processing speeds at a memory system in accordance with examples as disclosed herein.

FIG. 5 shows a flowchart illustrating a method or methods that support configurable write processing speeds at a memory system in accordance with examples as disclosed herein.

### DETAILED DESCRIPTION

Memory systems may support various management operations and schemes associated with storing data to memory arrays. For example, a memory system may maintain logical-to-physical (L2P) mappings for data, such that logical addresses (e.g., logical block addresses (LBAs)) associated with host data are mapped to physical addresses (e.g., physical pointer addresses (PPAs)) within a memory array of the memory system. In some cases, the memory system may partition one or more memory arrays into various regions and may maintain a respective L2P table for each region (e.g., to identify LBAs of data stored to the corresponding region). When the memory system receives a write command from a host system, the memory system may store an L2P mapping for the data indicated by the write command in one or more changelogs (e.g., data structures configured to temporarily store recently received L2P mappings). For example, the memory system may include an active foreground changelog (AL) and a background changelog (BL) stored to volatile memory (e.g., leveraging relatively quick access speeds), where the AL may serve as an interface with the host system for receiving the L2P mappings and the BL may be used by the memory system to sort and flush L2P mappings to corresponding regions of the memory system.

In some examples, the memory system may track a quantity of regions associated with L2P mappings stored to a changelog. For example, after storing an L2P mapping to the AL, the memory system may identify whether a quantity of regions associated with the L2P mappings stored to the AL satisfies (e.g., exceeds) a threshold quantity. If the quantity of regions associated with L2P mappings stored to the AL satisfies the threshold quantity, the memory system may transfer the L2P mappings from the AL to the BL and may begin loading the L2P tables from each region of the quantity of regions (e.g., to flush the L2P mappings to the appropriate regions). In some examples, the memory system may continue to receive write commands from the host system and may store new L2P mappings in the AL while still flushing L2P mappings from the BL. In such examples, if the memory system receives L2P mappings in the AL associated with the threshold quantity of regions, the memory system may suspend service of subsequent requests from the host system for a duration (e.g., a flow control state) to allow for the L2P mappings to be flushed from the BL to the regions of the memory arrays. Such suspension may be more likely to occur when the memory system receives large quantities of random write commands (e.g., relative to when sequential write commands are received), due to random write commands being more likely to involve different regions of memory. However, suspending service requests may incur significant latency, limit the ability of the memory system to service high-priority requests from the host system, cause an error condition or otherwise unacceptable behavior from the perspective of the host system, or any combination thereof, thereby reducing overall performance by the memory system.

Techniques described herein provide for a memory system to adjust a write speed for processing random write commands based on a quantity of regions associated with L2P mappings stored to an AL satisfying a threshold quantity while one or more entries are being flushed from a BL. For example, the memory system may slow the write processing speed when the memory system identifies that change entries within the AL correspond to the threshold quantity of memory regions while entries remain to be flushed in the BL. By slowing the write processing speed, the memory system may allow for additional time for the memory system flush L2P mappings from the BL while still receiving write commands and populating the AL with new L2P mappings. For example, due to slowing the write processing speed, a duration associated with new L2P mappings within the AL satisfying the threshold quantity of memory regions (e.g., triggering suspension of requests) may be increased, thereby reducing a frequency of the suspension. Additionally, slowing the write processing speed may enable the memory system to increase the threshold quantity of memory regions without incurring additional latency when flushing L2P mappings to the memory arrays. For example, due to the write requests including random write data, an increased quantity of regions supported by the memory system in the changelogs may increase a likelihood that random write data is associated with a region that is already present in the changelogs (e.g., therefore not contributing to the region threshold being satisfied). Such techniques may improve memory system performance when receiving large quantities of random write requests by eliminating or otherwise mitigating durations where the memory system suspends service of host system requests.

In addition to applicability in memory systems as described herein, techniques for configurable write processing speeds may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by avoiding suspension of servicing requests resulting from executing large quantities of random write requests, which may decrease processing or latency times, improve response times, or otherwise improve user experience, among other benefits.

In addition to applicability in memory systems as described herein, techniques for configurable write processing speeds may be generally implemented to support edge computing applications. Edge computing is a distributed computing paradigm that brings computation and data storage closer to the sources of data than traditional cloud services. As the use of edge computing to provide computing, storage, and networking services at locations that are geographically closer to end users increases, many devices and systems may benefit from improved processing, performance, and storage at edge devices. For example, increasing memory density, capacity, and processing power of edge devices may decrease a reliance on the devices to remote computing or devices, which may otherwise increase latency of operations performed at the devices. Implementing the techniques described herein may support edge computing techniques by improving response times associated with edge computing devices, among other benefits.

Features of the disclosure are illustrated and described in the context of systems, devices, and circuits. Features of the disclosure are further illustrated and described in the context of a changelog management scheme, a process, and flowcharts.

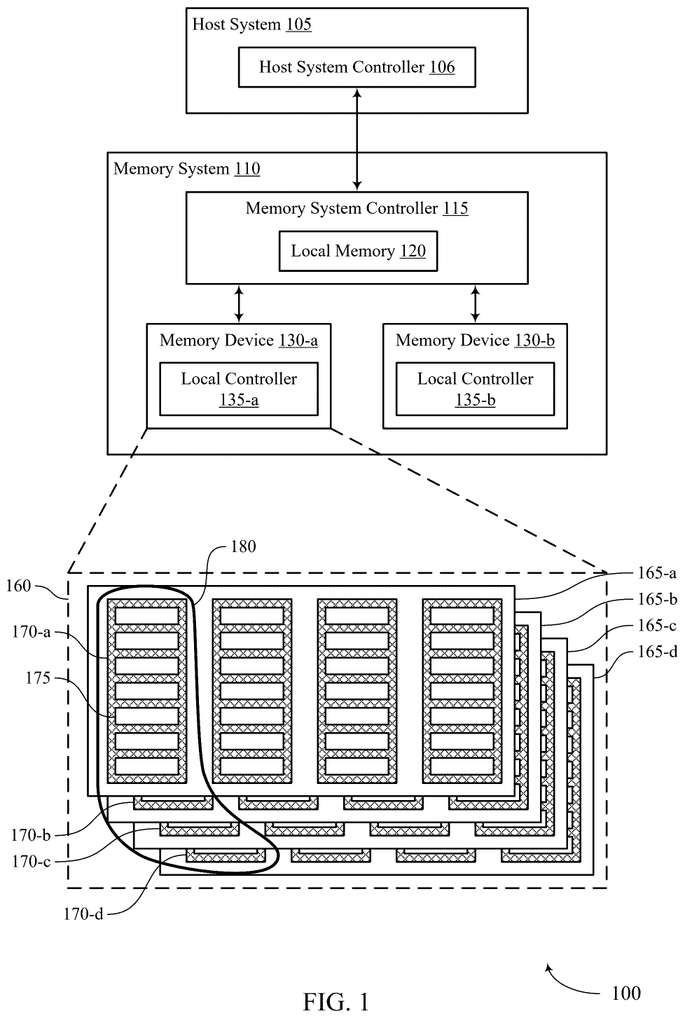

FIG. 1 shows an example of a system 100 that supports configurable write processing speeds at a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update an L2P mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some examples of the system 100, a memory system 110 may maintain L2P mappings for data, such that logical addresses (e.g., LBAs) associated with host commands are mapped to physical addresses (e.g., PPAs) within a memory array of the memory system 110. In some cases, the memory system 110 may partition one or more memory arrays into various regions and may maintain a respective L2P table for each region (e.g., to identify LBAs of data stored to the corresponding region). When the memory system 110 receives a write command from a host system 105, the memory system 110 may store an L2P mapping for the data indicated by the write command in one or more changelogs (e.g., data structures configured to store recently received L2P mappings). For example, the memory system 110 may include an AL and a BL stored to volatile memory (e.g., leveraging relatively quick access speeds), where the AL may serve as an interface with the host system 105 for receiving the L2P mappings and the BL may be used by the memory system 110 to sort and flush L2P mappings to corresponding regions of the memory system 110.

In some examples, the memory system 110 may track a quantity of regions associated with L2P mappings stored to a changelog. For example, after storing an L2P mapping to the AL, the memory system 110 may identify whether a quantity of regions associated with the L2P mappings stored to the AL satisfies (e.g., exceeds) a threshold quantity. If the quantity of regions associated with L2P mappings stored to the AL satisfies the threshold quantity, the memory system 110 may transfer the L2P mappings from the AL to the BL and may begin loading the L2P tables from each region of the quantity of regions (e.g., to flush the L2P mappings to the appropriate regions). In some examples, the memory system 110 may continue to receive write commands from the host system 105 and may store new L2P mappings in the AL while still flushing L2P mappings from the BL. In such examples, if the memory system 110 receives second L2P mappings in the AL associated with the threshold quantity of regions, the memory system 110 may suspend service of subsequent requests from the host system 105 for a duration (e.g., a flow control state) to allow for the L2P mappings to be flushed from the BL to the regions of the memory arrays. Such suspension may be more likely to occur when the memory system 110 receives large quantities of random write commands (e.g., relative to when sequential write commands are received), due to random write commands being more likely to involve different regions of memory. However, suspending service requests may incur significant latency, limit the ability of the memory system 110 to service high-priority requests from the host system 105, cause an error condition or otherwise unacceptable behavior from the perspective of the host system 105, or any combination thereof, thereby reducing overall performance by the memory system 110.

Techniques described herein provide for a memory system 110 to adjust a write speed for processing random write commands based on a quantity of regions associated with L2P mappings stored to an AL satisfying a threshold quantity. For example, the memory system 110 may slow the write processing speed when the memory system 110 identifies that change entries within the AL correspond to the threshold quantity of memory regions. By slowing the write processing speed, the memory system 110 may allow for additional time for the memory system 110 flush L2P mappings from the BL while still receiving write commands and populating the AL with new L2P mappings. For example, due to slowing the write processing speed, a duration associated with new L2P mappings within the AL satisfying the threshold quantity of memory regions (e.g., triggering suspension of requests) may be increased, thereby reducing a frequency of the suspension and a latency impact of the suspension. Additionally, slowing the write processing speed may enable the memory system 110 to increase the threshold quantity of memory regions without incurring additional latency when flushing L2P mappings to the memory arrays. For example, due to the write requests including random write data, an increased quantity of regions supported by the memory system 110 in the changelogs may increase a likelihood that random write data is associated with a region that is already present in the changelogs (e.g., therefore not contributing to the region threshold being satisfied). Such techniques may improve memory system 110 performance when receiving large quantities of random write requests by eliminating or otherwise mitigating durations where the memory system suspends service of host system 105 requests.

The system 100 may include any quantity of non-transitory computer readable media that support configurable write processing speeds at a memory system. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

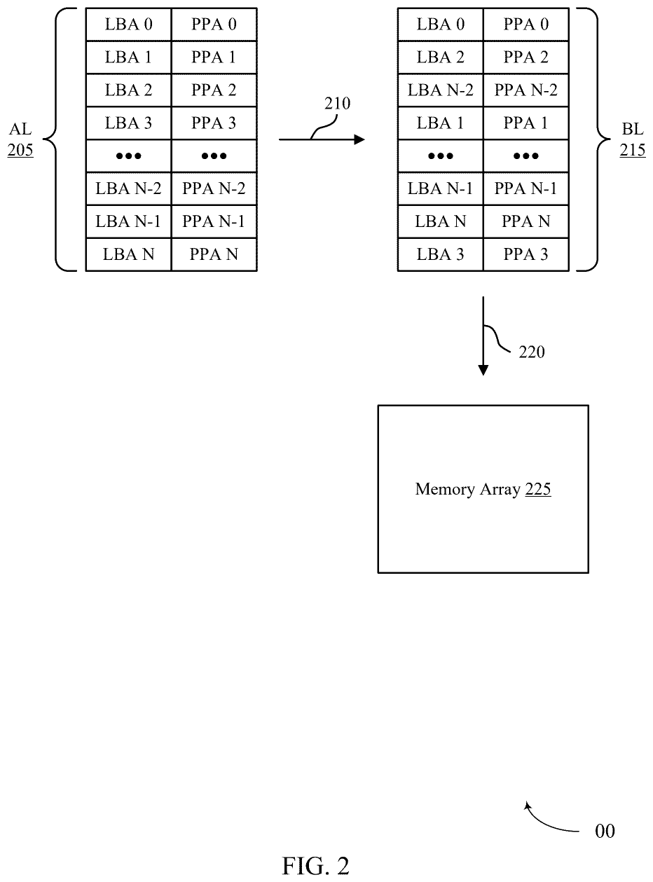

FIG. 2 shows an example of a changelog management scheme 200 that supports configurable write processing speeds at a memory system in accordance with examples as disclosed herein. The changelog management scheme 200 may implement, or be implemented by, one or more aspects of the system 100. For example, the changelog management scheme 200 may show an example of changelogs maintained by a memory system to store L2P mappings associated with data received from a host device, which may be examples of corresponding devices and aspects described with reference to FIG. 1. The memory system may support one or more operations associated with transferring L2P mappings between changelogs and flushing the L2P mappings to various regions of a memory array.

In some cases, the memory system may receive write commands (e.g., random write requests) from the host system, and may store L2P mappings associated with data indicated by the write commands in an AL 205. The AL 205 may be an interface between the memory system and the host system (e.g., the AL 205 may be visible to the host system) and the host system may write the L2P mappings to the AL 205 with the write commands. As an example, a first entry of the AL 205 (e.g., LBA 0, PPA 0) may correspond to first data indicated by a first write command, a second entry of the AL 205 (e.g., LBA 1, PPA 1) may correspond to second data indicated by a second write command, and so on (e.g., the AL 205 may store N entries for N write commands, where N may be any integer value). The L2P mappings may be associated with various memory regions of the memory system (e.g., partitions of one or more memory arrays), which may be indicated by the PPA of each entry.

In some examples, the memory system may support an operation 210 associated with transferring L2P mappings from the AL 205 to a BL 215. The BL 215 may be used by the memory system for flushing L2P mappings to L2P tables of corresponding memory regions, and may be transparent to the host system (e.g., the memory system may perform flushing operations as a background process). In some cases, the operation 210 may include transferring the L2P mappings to the BL 215 as well as sorting the L2P mappings according to memory region. In the example illustrated by the changelog management scheme 200, the operation 210 may result in sequential entries of the BL 215 corresponding to similar regions. For example, PPA 0, PPA 2, PPA N−2, and PPA 1 (e.g., corresponding to entries 1 through 4 of the BL 215) may each correspond to a location within a first memory region, and PPA N−1, PPA N, and PPA 3 (e.g., corresponding to entries N−2 through N of the BL 215) may each correspond to a location within a second memory region different from the first memory region. Such sorting may support the memory system performing an operation 220 associated with flushing the L2P mappings from the BL 215 to a memory array 225 (which may be an example of one or more memory arrays of one or more memory devices 130 described with reference to FIG. 1).

The operation 220 may include the memory system loading L2P tables associated with each region present in the BL 215 and transferring the L2P mappings from the BL 215 to the loaded L2P tables. For example, as part of the operation 220, the memory system may load a first L2P table associated with the first memory region, and may transfer L2P mappings with PPAs belonging to the first memory region from the BL 215 to the first L2P table. The memory system may load each L2P table associated with a region present in the BL 215 until each mapping is flushed from the BL 215. In some cases, while performing the operation 220, the memory system may continue to receive write requests from the host system and populate the AL 205 with new mappings.

In some examples, the operation 210 may be triggered once a quantity of regions present in the AL 205 satisfies a threshold quantity of memory regions. For example, the operation 210 may be triggered to clear the AL 205 and initiate the operation 220 to flush the mappings to the memory array 225. However, if the operation 220 is not yet complete and the memory system receives new L2P mappings in the AL 205 that satisfy the threshold quantity, the memory system may suspend serving subsequent write requests for a duration to allow for the operation 220 to complete. Such suspension may incur significant latency at the memory system. To eliminate or otherwise mitigate this latency, the memory system may slow a write speed for processing random write requests once the threshold quantity of memory regions is triggered and a flushing operation is still in progress (e.g., when the operation 210 is initiated while the operations 220 is in progress). By slowing the write speed, the memory system may allow for sufficient time for the operation 220 to complete without suspending servicing requests, thereby improving memory system performance when receiving relatively large amounts of random write data.

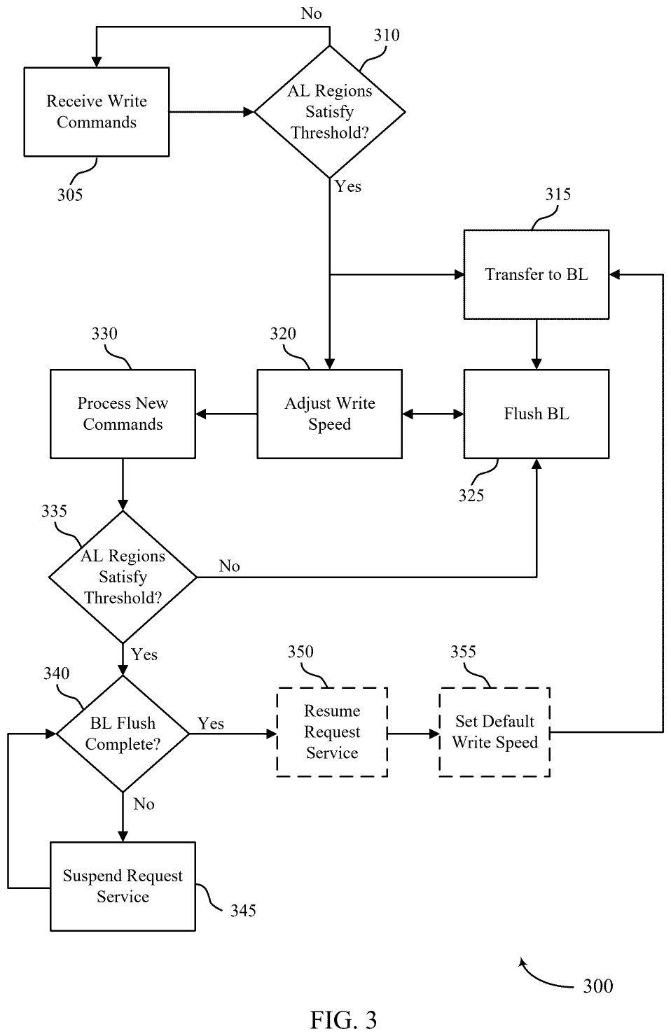

FIG. 3 shows an example of a process 300 that supports configurable write processing speeds at a memory system in accordance with examples as disclosed herein. The process 300 may implement, or be implemented by, one or more aspects of the system 100 and the changelog management scheme 200. For example, the process 300 may show operations and decisions performed by a memory system in association with managing L2P data stored to one or more changelogs, which may be examples of corresponding devices and aspects described with reference to FIGS. 1 and 2. The process 300 may support the memory system adjusting a write speed for processing random write requests received from a host system according to a quantity of regions associated with mappings stored to the one or more changelogs, which may support the memory system performing operations associated with flushing the mappings to a memory array without suspending service of subsequent requests. Alternative examples of the following may be implemented, where some processes are performed in a different order than described or are not performed. In some cases, processes may include additional features not mentioned below, or further processes may be added.

At 305, one or more write commands may be received. For example, a controller of a memory system (e.g., a memory system controller 115 described with reference to FIG. 1) may receive a first set of multiple write commands, which may include one or more requests to write random (e.g., non-sequential) first sets of data to one or more memory arrays of the memory system. In some cases, based on receiving the write commands, the memory system controller may write, to an AL (e.g., a first changelog) of the memory system, first mappings indicating relationships between first LBAs and first PPAs associated with the first sets of data. In some cases, the memory system may process the first set of multiple commands according to a first write speed.

At 310, whether the AL includes entries corresponding to a quantity of memory regions that satisfies a threshold quantity may be determined. For example, the memory system controller may determine whether a first quantity of memory regions associated with the first mappings satisfies the threshold quantity. In some cases, a memory region may be an example of a portion of a memory array logically partitioned by the memory system, where the memory system may maintain, for each memory region, an L2P table mapping LBAs to the PPAs of the memory region. If the memory system identifies that the first quantity of regions fails to satisfy the threshold quantity, the memory system may return to step 305 of the process 300 and continue to receive write commands. Alternatively, if the memory system identifies that the first quantity of regions satisfies the threshold quantity, the memory system may proceed to steps 315 and 320 of the process 300. For example, in response to identifying that the first quantity of regions satisfies the threshold quantity, the memory system may begin performing the operations at step 315 and step 320 concurrently.

At 315, the mappings may be transferred to a BL. For example, the memory system controller may transfer the first mappings from the AL to the BL, which may support the memory system performing operations to flush the first mappings from the BL while concurrently processing new commands from the host system. In some examples, the memory system controller may sort the first mappings according to memory region (e.g., sets of sequential entries of the BL may correspond to a common memory region) as part of transferring the first mappings to the BL. In some cases, based on transferring the first mappings from the AL to the BL, the memory system may proceed to step 325 of the process 300 to perform a flushing operation at the BL.

At 320, a write speed may be adjusted. For example, the memory system controller may adjust (e.g., slow) the first write speed for processing subsequent commands received by the memory system. In some cases, the memory system may adjust the write speed based on a quantity of regions associated with mappings stored to the BL. For example, the memory system may adjust the write speed according to the quantity of regions present in the BL (e.g., which may include the first quantity of regions, such as directly after transferring the first mappings from the AL to the BL). The memory system may apply a delay (e.g., L) to the first write speed (e.g., a default write speed) to obtain a second (e.g., adjusted) write speed that is slower than the first write speed. For example, to process commands according to the second write speed, firmware of the memory system may bypass a task associated with a write command a quantity of times to introduce the delay for each write operation (e.g., for each 4 KB write). In some examples, the delay may correspond to a first value when the quantity of regions associated with the first mappings satisfies the threshold quantity. For example, the memory system may compare the quantity of regions (e.g., a current quantity of regions in the BL based on the progress of the BL flushing operation, which may be referred to as Rtbl) to a single threshold value to determine whether to apply the delay to the first write speed (e.g., a simple delay curve). Additionally, or alternatively, the delay may correspond to a second value that is greater than the first value when the quantity of regions associated with the first mappings satisfies a second threshold quantity that is greater than the threshold quantity. For example, the memory system may compare the quantity of regions to multiple thresholds to determine a magnitude of the delay (e.g., a dynamic delay curve), where the first value may be dynamic and based on the quantity of regions and the threshold (e.g., L=(Rtbl−Threshold_1)*a, where a is an integer scaling factor) and the second value may correspond to an upper bound of latencies (e.g., a maximum latency) supported by the memory system when the quantity of regions satisfies the second threshold.

At 325, the BL may be flushed. For example, the memory system controller may begin transferring the first mappings from the BL to a set of L2P tables associated with a set of regions included in the first mappings. In some cases, flushing the BL may include the memory system loading an L2P table associated with each region present in the first mappings, where a respective mapping of the first mappings may be associated with a region based on a respective set of data associated with the respective mapping being stored to the region (e.g., a PPA indicated by the mapping is located in the region). To perform the flushing operation, the memory system may store each of the first mappings to an L2P table of a corresponding region and may delete the mapping from the BL.

In some examples, while flushing the BL, the memory system may monitor the quantity of regions present in the BL to determine a write speed for processing received commands. For example, as the memory system flushes the BL and removes mappings from the BL, the quantity of regions present in the BL may be reduced, and the memory system may determine whether a current quantity of regions in the BL satisfies the one or more threshold values for determining write speed (e.g., discussed with respect to step 320 of the process 300). As an example, the memory system may initially operate at the second write speed when each region of the first mappings is present in the BL (e.g., before flushing any BL mappings), and may adjust the write speed to a third write speed as the BL is flushed if the quantity of regions drops below a threshold value, where the third write speed may be faster than the second write speed and slower than the first write speed (e.g., dynamically updating the write speed as the quantity of regions in the BL changes). In some examples, the memory system may adjust the write speed back to the first write speed, such as if the quantity of regions present in the BL is below a threshold value that indicates the first write speed is sufficient for processing new commands (e.g., a lower-bound threshold).

At 330, new commands may be processed. For example, the memory system controller may receive and process a second set of multiple commands indicating to write second sets of data to the memory system. In some cases, the memory system may process the second set of commands according to a current write speed of the memory system. For example, the memory system may process the second commands according to the second write speed that is slower than the first write speed (e.g., due to the adjusting the first write speed in response to the first mappings including the threshold quantity of regions), or another write speed that was adjusted based on the quantity of regions present in the BL. As part of processing the second commands, the memory system may store, in the AL, second mappings indicating second relationships between second LBAs and second PPAs associated with the second sets of data.

By processing the second set of commands according to the adjusted write speed, the memory system may allow for additional time for the flushing operation at the BL to complete while still servicing requests from the host system. Additionally, slowing the write speed may support the memory system increasing the threshold quantity of regions supported in the changelogs. For example, due to the second commands including random write data, an increased threshold quantity of memory regions may increase the likelihood than a random write will be associated with a region already present in the AL and thus not contributing to the region threshold being triggered and not introducing latency to the flushing process once the second sets of data are transferred to the BL (e.g., since the appropriate L2P table will have been already loaded for a different entry). In some examples, such techniques may allow the memory system to set the threshold quantity of regions to the capacity of the changelogs (e.g., 8 KB), which may reduce memory utilization associated with recording which regions are present in the changelogs.

At 335, whether the AL includes entries corresponding to a quantity of memory regions that satisfies the threshold quantity may be determined. For example, the memory system controller may determine whether a second quantity of regions associated with the second mappings satisfies the threshold quantity of memory regions. If the memory system determines that the second quantity of regions satisfies the threshold quantity of memory regions, the memory system may proceed to step 340 of the process 300. Alternatively, if the memory system determines that the second quantity of regions fails to satisfy the threshold quantity of memory regions, the memory system may proceed to step 325 of the process 300 and continue flushing the BL and processing new commands.

At 340, whether the BL flush is complete may be determined. For example, the memory system controller may determine whether one or more entries remain to be flushed from the BL. In some examples, the memory system may determine whether the BL flush is complete based on determining that the second quantity of regions satisfies the threshold quantity of memory regions. For example, if the region threshold within the AL is triggered and the memory system determines that the BL flush is not complete, the memory system may proceed to step 345 of the process 300. Alternatively, if the region threshold within the AL is triggered and the memory system determines that the BL flush is complete, the memory system may proceed to step 350 of the process 300.

At 345, servicing requests may be suspended. For example, the memory system controller may suspend servicing one or more subsequent requests from the host system for a duration. In some cases, the suspension may be based on the AL including entries corresponding to a quantity of regions that satisfies the threshold quantity of regions while the memory system is in the process of flushing entries from the BL. For example, due to the BL still including the first mappings (e.g., if the flush is incomplete) and the AL including the second mappings, the memory system may suspend service of the subsequent requests in order to complete the flush of the BL (e.g., prior to transferring the second mappings from the AL to the BL). In some examples, slowing the write speed in response to the BL including the threshold quantity of regions may eliminate such suspensions or reduce the duration associated with the suspension, thereby mitigating latency associated with handling large quantities of random write requests at the memory system. In some cases, the memory system may continue to monitor whether the BL flush is complete (e.g., returning to step 340 of the process 300) after suspending the servicing of requests.

At 350, servicing requests may be resumed. For example, the memory system controller may resume servicing requests, such as in the event that the memory system suspended servicing requests at step 345 (e.g., when the second mappings include the threshold quantity of regions before the BL flush is complete). In some cases, resuming servicing requests may be based on the memory system completing the BL flush by transferring the mappings stored to the BL from the BL to corresponding L2P tables (e.g., regional L2P tables) of the memory system. Alternatively, the memory system may complete the BL flush without suspending servicing requests from the host system, such as when the second mappings do not include the threshold quantity of regions by the time the BL flush is complete (e.g., the BL flush is determined to be complete at step 340 without the memory system proceeding to step 345).

At 355, the write speed may be set to a default value. For example, the memory system may set the write speed back to the first write speed (e.g., omitting the delay) based on completing the BL flush. In some cases, the memory system may transfer the mappings included in the AL (e.g., the second mappings or one or more subsequent sets of mappings) to the BL based on resetting the write speed, and may continue the steps of the process 300 to flush the BL, adjust the write speed (e.g., dynamically according to the progress of the BL flush), and process new commands in the AL according to the adjusted write speed.

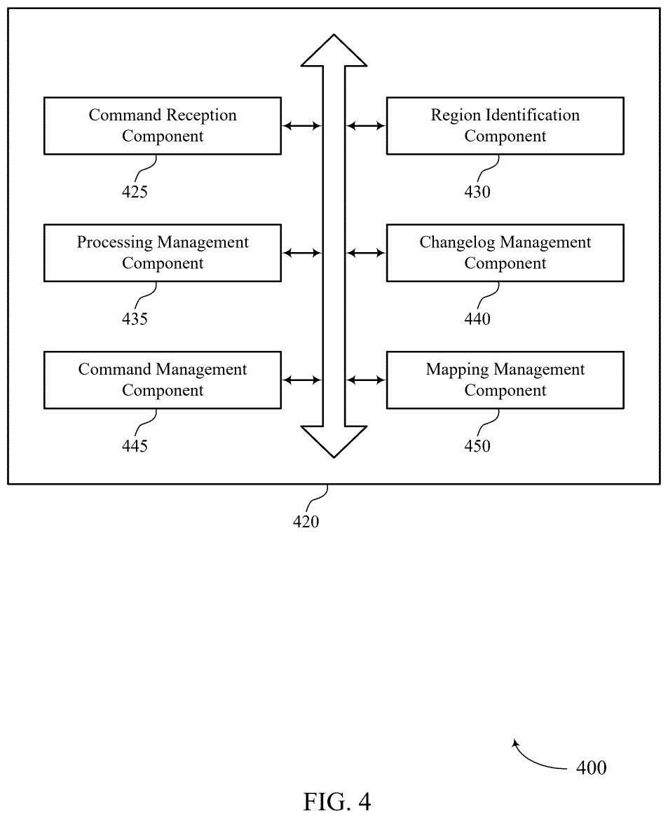

FIG. 4 shows a block diagram 400 of a memory system 420 that supports configurable write processing speeds at a memory system in accordance with examples as disclosed herein. The memory system 420 may be an example of aspects of a memory system as described with reference to FIGS. 1 through 3. The memory system 420, or various components thereof, may be an example of means for performing various aspects of configurable write processing speeds at a memory system as described herein. For example, the memory system 420 may include a command reception component 425, a region identification component 430, a processing management component 435, a changelog management component 440, a command management component 445, a mapping management component 450, or any combination thereof. Each of these components, or components of subcomponents thereof (e.g., one or more processors, one or more memories), may communicate, directly or indirectly, with one another (e.g., via one or more buses).

The command reception component 425 may be configured as or otherwise support a means for receiving a first plurality of write commands indicating to write first sets of data to the memory system, where the first plurality of write commands are processed by the memory system according to a first write speed. The region identification component 430 may be configured as or otherwise support a means for determining, in response to receiving the first plurality of write commands, whether the first sets of data are associated with a first quantity of regions of the memory system that satisfies a threshold quantity of regions. In some examples, the command reception component 425 may be configured as or otherwise support a means for receiving a second plurality of write commands indicating to write second sets of data to the memory system, where the second plurality of write commands are processed by the memory system according to a second write speed that is slower than the first write speed in response to the first quantity of regions satisfying the threshold quantity of regions.

In some examples, the processing management component 435 may be configured as or otherwise support a means for applying a delay to the first write speed to obtain the second write speed, where the delay corresponds to a first value when the first quantity of regions satisfies the threshold quantity of regions, and where the delay corresponds to a second value that is greater than the first value when the first quantity of regions satisfies a second threshold quantity of regions that is greater than the threshold quantity of regions.

In some examples, the changelog management component 440 may be configured as or otherwise support a means for writing, to a first changelog of the memory system and in response to receiving the first plurality of write commands, first mappings indicating a plurality of first relationships between first logical addresses and first physical addresses associated with the first sets of data. In some examples, the changelog management component 440 may be configured as or otherwise support a means for transferring, in response to the first quantity of regions satisfying the threshold quantity of regions, the first mappings from the first changelog to a second changelog of the memory system. In some examples, the changelog management component 440 may be configured as or otherwise support a means for writing, to the first changelog and in response to receiving the second plurality of write commands, second mappings indicating a plurality of second relationships between second logical addresses and second physical addresses associated with the second sets of data, where writing the second mappings to the first changelog occurs after transferring the first mappings to the second changelog.

In some examples, the mapping management component 450 may be configured as or otherwise support a means for transferring, after transferring the first mappings from the first changelog to the second changelog, the first mappings from the second changelog to a set of logical-to-physical tables associated with a set of regions included in the first quantity of regions, where a respective mapping within the first mappings is associated with a region within the first quantity of regions in accordance with a respective set of data that is associated with the respective mapping being stored to the region.

In some examples, the changelog management component 440 may be configured as or otherwise support a means for transferring, after transferring the first mappings from the second changelog to the set of logical-to-physical tables, the second mappings from the first changelog to the second changelog. In some examples, the command reception component 425 may be configured as or otherwise support a means for receiving a third plurality of write commands indicating to write third sets of data to the memory system, where the third plurality of write commands are processed by the memory system according to the first write speed after transferring the second mappings from the first changelog to the second changelog.

In some examples, the first changelog is an active foreground changelog and the second changelog is a background changelog.

In some examples, the region identification component 430 may be configured as or otherwise support a means for determining, in response to receiving the second plurality of write commands, whether the second sets of data are associated with a second quantity of regions that satisfies the threshold quantity of regions. In some examples, the command management component 445 may be configured as or otherwise support a means for suspending, for a duration, servicing of one or more subsequent commands in response to the second quantity of regions satisfying the threshold quantity of regions.

In some examples, the first plurality of write commands and the second plurality of write commands both include random write commands.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

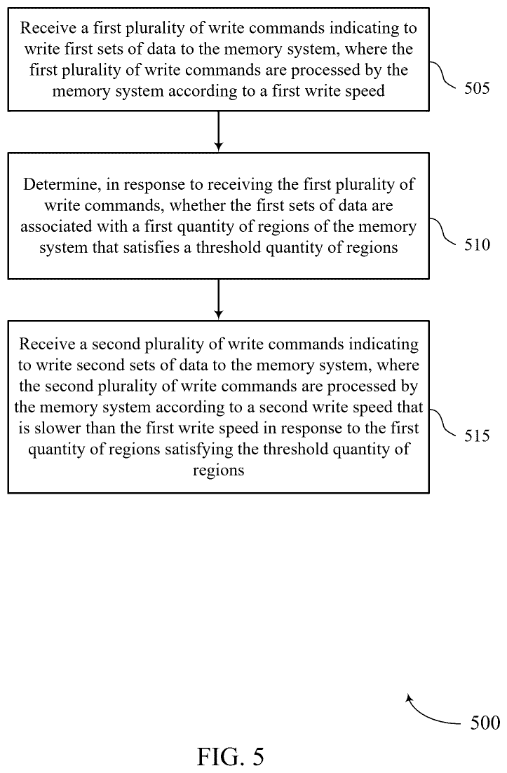

FIG. 5 shows a flowchart illustrating a method 500 that supports configurable write processing speeds at a memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving a first plurality of write commands indicating to write first sets of data to the memory system, where the first plurality of write commands are processed by the memory system according to a first write speed. In some examples, aspects of the operations of 505 may be performed by a command reception component 425 as described with reference to FIG. 4.

At 510, the method may include determining, in response to receiving the first plurality of write commands, whether the first sets of data are associated with a first quantity of regions of the memory system that satisfies a threshold quantity of regions. In some examples, aspects of the operations of 510 may be performed by a region identification component 430 as described with reference to FIG. 4.

At 515, the method may include receiving a second plurality of write commands indicating to write second sets of data to the memory system, where the second plurality of write commands are processed by the memory system according to a second write speed that is slower than the first write speed in response to the first quantity of regions satisfying the threshold quantity of regions. In some examples, aspects of the operations of 515 may be performed by a command reception component 425 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a first plurality of write commands indicating to write first sets of data to the memory system, where the first plurality of write commands are processed by the memory system according to a first write speed; determining, in response to receiving the first plurality of write commands, whether the first sets of data are associated with a first quantity of regions of the memory system that satisfies a threshold quantity of regions; and receiving a second plurality of write commands indicating to write second sets of data to the memory system, where the second plurality of write commands are processed by the memory system according to a second write speed that is slower than the first write speed in response to the first quantity of regions satisfying the threshold quantity of regions.

Aspect 2: The method, apparatus, or non-transitory computer-readable medium of aspect 1, further including operations, features, circuitry, logic, means, or instructions, or any combination thereof for applying a delay to the first write speed to obtain the second write speed, where: the delay corresponds to a first value when the first quantity of regions satisfies the threshold quantity of regions; and the delay corresponds to a second value that is greater than the first value when the first quantity of regions satisfies a second threshold quantity of regions that is greater than the threshold quantity of regions.

Aspect 3: The method, apparatus, or non-transitory computer-readable medium of any of aspects 1 through 2, further including operations, features, circuitry, logic, means, or instructions, or any combination thereof for writing, to a first changelog of the memory system and in response to receiving the first plurality of write commands, first mappings indicating a plurality of first relationships between first logical addresses and first physical addresses associated with the first sets of data; transferring, in response to the first quantity of regions satisfying the threshold quantity of regions, the first mappings from the first changelog to a second changelog of the memory system; and writing, to the first changelog and in response to receiving the second plurality of write commands, second mappings indicating a plurality of second relationships between second logical addresses and second physical addresses associated with the second sets of data, where writing the second mappings to the first changelog occurs after transferring the first mappings to the second changelog.

Aspect 4: The method, apparatus, or non-transitory computer-readable medium of aspect 3, further including operations, features, circuitry, logic, means, or instructions, or any combination thereof for transferring, after transferring the first mappings from the first changelog to the second changelog, the first mappings from the second changelog to a set of logical-to-physical tables associated with a set of regions included in the first quantity of regions, where a respective mapping within the first mappings is associated with a region within the first quantity of regions in accordance with a respective set of data that is associated with the respective mapping being stored to the region.

Aspect 5: The method, apparatus, or non-transitory computer-readable medium of aspect 4, further including operations, features, circuitry, logic, means, or instructions, or any combination thereof for transferring, after transferring the first mappings from the second changelog to the set of logical-to-physical tables, the second mappings from the first changelog to the second changelog and receiving a third plurality of write commands indicating to write third sets of data to the memory system, where the third plurality of write commands are processed by the memory system according to the first write speed after transferring the second mappings from the first changelog to the second changelog.

Aspect 6: The method, apparatus, or non-transitory computer-readable medium of any of aspects 3 through 5, where the first changelog includes an active foreground changelog and the second changelog includes a background changelog.

Aspect 7: The method, apparatus, or non-transitory computer-readable medium of any of aspects 1 through 6, further including operations, features, circuitry, logic, means, or instructions, or any combination thereof for determining, in response to receiving the second plurality of write commands, whether the second sets of data are associated with a second quantity of regions that satisfies the threshold quantity of regions and suspending, for a duration, servicing of one or more subsequent commands in response to the second quantity of regions satisfying the threshold quantity of regions.

Aspect 8: The method, apparatus, or non-transitory computer-readable medium of any of aspects 1 through 7, where the first plurality of write commands and the second plurality of write commands include random write commands.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open- ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a first plurality of write commands indicating to write first sets of data to the memory system, wherein the processing circuitry is configured to cause the memory system to process the first plurality of write commands according to a first write speed;
determine, in response to receiving the first plurality of write commands, whether the first sets of data are associated with a first quantity of regions of the memory system that satisfies a threshold quantity of regions; and
receive a second plurality of write commands indicating to write second sets of data to the memory system, wherein the processing circuitry is configured to cause the memory system to process the second plurality of write commands according to a second write speed that is slower than the first write speed in response to the first quantity of regions satisfying the threshold quantity of regions.

2. The memory system of claim 1, wherein the processing circuitry is further configured to cause the memory system to:
apply a delay to the first write speed to obtain the second write speed, wherein:
the delay corresponds to a first value when the first quantity of regions satisfies the threshold quantity of regions; and
the delay corresponds to a second value that is greater than the first value when the first quantity of regions satisfies a second threshold quantity of regions that is greater than the threshold quantity of regions.

3. The memory system of claim 1, wherein the processing circuitry is further configured to cause the memory system to:
write, to a first changelog of the memory system and in response to receiving the first plurality of write commands, first mappings indicating a plurality of first relationships between first logical addresses and first physical addresses associated with the first sets of data;
transfer, in response to the first quantity of regions satisfying the threshold quantity of regions, the first mappings from the first changelog to a second changelog of the memory system; and
write, to the first changelog and in response to receiving the second plurality of write commands, second mappings indicating a plurality of second relationships between second logical addresses and second physical addresses associated with the second sets of data, wherein the processing circuitry is configured to cause the memory system to write the second mappings to the first changelog after transferring the first mappings to the second changelog.

4. The memory system of claim 3, wherein the processing circuitry is further configured to cause the memory system to:
transfer, after transferring the first mappings from the first changelog to the second changelog, the first mappings from the second changelog to a set of logical-to-physical tables associated with a set of regions included in the first quantity of regions, wherein a respective mapping within the first mappings is associated with a region within the first quantity of regions in accordance with a respective set of data that is associated with the respective mapping being stored to the region.

5. The memory system of claim 4, wherein the processing circuitry is further configured to cause the memory system to:
transfer, after transferring the first mappings from the second changelog to the set of logical-to-physical tables, the second mappings from the first changelog to the second changelog; and
receive a third plurality of write commands indicating to write third sets of data to the memory system, wherein the processing circuitry is configured to cause the memory system to process the third plurality of write commands according to the first write speed after transferring the second mappings from the first changelog to the second changelog.

6. The memory system of claim 3, wherein the first changelog comprises an active foreground changelog and the second changelog comprises a background changelog.

7. The memory system of claim 1, wherein the processing circuitry is further configured to cause the memory system to:
determine, in response to receiving the second plurality of write commands, whether the second sets of data are associated with a second quantity of regions that satisfies the threshold quantity of regions; and
suspend, for a duration, servicing of one or more subsequent commands in response to the second quantity of regions satisfying the threshold quantity of regions.

8. The memory system of claim 1, wherein the first plurality of write commands and the second plurality of write commands comprise random write commands.

9. A non-transitory computer-readable medium storing code, the code comprising instructions executable by one or more processors to:
receive a first plurality of write commands indicating to write first sets of data to a memory system, wherein the instructions are executable by the one or more processors to process the first plurality of write commands according to a first write speed;
determine, in response to receiving the first plurality of write commands, whether the first sets of data are associated with a first quantity of regions of the memory system that satisfies a threshold quantity of regions; and
receive a second plurality of write commands indicating to write second sets of data to the memory system, wherein the instructions are executable by the one or more processors to process the second plurality of write commands according to a second write speed that is slower than the first write speed in response to the first quantity of regions satisfying the threshold quantity of regions.

10. The non-transitory computer-readable medium of claim 9, wherein the instructions are further executable by the one or more processors to:
apply a delay to the first write speed to obtain the second write speed, wherein:
the delay corresponds to a first value when the first quantity of regions satisfies the threshold quantity of regions; and
the delay corresponds to a second value that is greater than the first value when the first quantity of regions satisfies a second threshold quantity of regions that is greater than the threshold quantity of regions.

11. The non-transitory computer-readable medium of claim 9, wherein the instructions are further executable by the one or more processors to:
write, to a first changelog of the memory system and in response to receiving the first plurality of write commands, first mappings indicating a plurality of first relationships between first logical addresses and first physical addresses associated with the first sets of data;
transfer, in response to the first quantity of regions satisfying the threshold quantity of regions, the first mappings from the first changelog to a second changelog of the memory system; and
write, to the first changelog and in response to receiving the second plurality of write commands, second mappings indicating a plurality of second relationships between second logical addresses and second physical addresses associated with the second sets of data, wherein the instructions are executable by the one or more processors to write the second mappings to the first changelog after transferring the first mappings to the second changelog.

12. The non-transitory computer-readable medium of claim 11, wherein the instructions are further executable by the one or more processors to:
transfer, after transferring the first mappings from the first changelog to the second changelog, the first mappings from the second changelog to a set of logical-to-physical tables associated with a set of regions included in the first quantity of regions, wherein a respective mapping within the first mappings is associated with a region within the first quantity of regions in accordance with a respective set of data that is associated with the respective mapping being stored to the region.

13. The non-transitory computer-readable medium of claim 12, wherein the instructions are further executable by the one or more processors to:
transfer, after transferring the first mappings from the second changelog to the set of logical-to-physical tables, the second mappings from the first changelog to the second changelog; and
receive a third plurality of write commands indicating to write third sets of data to the memory system, wherein the instructions are executable by the one or more processors to process the third plurality of write commands according to the first write speed after transferring the second mappings from the first changelog to the second changelog.

14. The non-transitory computer-readable medium of claim 11, wherein the first changelog comprises an active foreground changelog and the second changelog comprises a background changelog.

15. The non-transitory computer-readable medium of claim 9, wherein the instructions are further executable by the one or more processors to:
determine, in response to receiving the second plurality of write commands, whether the second sets of data are associated with a second quantity of regions that satisfies the threshold quantity of regions; and
suspend, for a duration, servicing of one or more subsequent commands in response to the second quantity of regions satisfying the threshold quantity of regions.

16. The non-transitory computer-readable medium of claim 9, wherein the first plurality of write commands and the second plurality of write commands comprise random write commands.

17. A method by a memory system, comprising:
receiving a first plurality of write commands indicating to write first sets of data to the memory system, wherein the first plurality of write commands are processed by the memory system according to a first write speed;
determining, in response to receiving the first plurality of write commands, whether the first sets of data are associated with a first quantity of regions of the memory system that satisfies a threshold quantity of regions; and
receiving a second plurality of write commands indicating to write second sets of data to the memory system, wherein the second plurality of write commands are processed by the memory system according to a second write speed that is slower than the first write speed in response to the first quantity of regions satisfying the threshold quantity of regions.

18. The method of claim 17, further comprising:
applying a delay to the first write speed to obtain the second write speed, wherein:
the delay corresponds to a first value when the first quantity of regions satisfies the threshold quantity of regions; and
the delay corresponds to a second value that is greater than the first value when the first quantity of regions satisfies a second threshold quantity of regions that is greater than the threshold quantity of regions.

19. The method of claim 17, further comprising:
writing, to a first changelog of the memory system and in response to the first plurality of write commands, first mappings indicating a plurality of first relationships between first logical addresses and first physical addresses associated with the first sets of data;
transferring, in response to the first quantity of regions satisfying the threshold quantity of regions, the first mappings from the first changelog to a second changelog of the memory system; and
writing, to the first changelog and in response to receiving the second plurality of write commands, second mappings indicating a plurality of second relationships between second logical addresses and second physical addresses associated with the second sets of data, wherein writing the second mappings to the first changelog occurs after transferring the first mappings to the second changelog.

20. The method of claim 19, further comprising:
transferring, after transferring the first mappings from the first changelog to the second changelog, the first mappings from the second changelog to a set of logical-to-physical tables associated with a set of regions included in the first quantity of regions, wherein a respective mapping within the first mappings is associated with a region within the first quantity of regions in accordance with a respective set of data that is associated with the respective mapping being stored to the region.

21. The method of claim 20, further comprising:
transferring, after transferring the first mappings from the second changelog to the set of logical-to-physical tables, the second mappings from the first changelog to the second changelog; and
receiving a third plurality of write commands indicating to write third sets of data to the memory system, wherein the third plurality of write commands are processed by the memory system according to the first write speed after transferring the second mappings from the first changelog to the second changelog.

22. The method of claim 19, wherein the first changelog comprises an active foreground changelog and the second changelog comprises a background changelog.

23. The method of claim 17, further comprising:
determining, in response to receiving the second plurality of write commands, whether the second sets of data are associated with a second quantity of regions that satisfies the threshold quantity of regions; and
suspending, for a duration, servicing of one or more subsequent commands in response to the second quantity of regions satisfying the threshold quantity of regions.

24. The method of claim 17, wherein the first plurality of write commands and the second plurality of write commands comprise random write commands.
